(19) United States
(12) Patent Application Publication
(10) Pub. No.: US 2012/0257418 A1
(43) Pub. Date: Oct. 11, 2012

(54) PROJECTION NIGHT LIGHT

(76) Inventors: Marc Howard Fields, Kingwood, TX (US); Li Dong Xie, Ningbo (CN)

(21) Appl. No.: 13/344,148

(22) Filed: Jan. 5, 2012

(30) Foreign Application Priority Data
Apr. 7, 2011 (CN) 201120108650
Nov. 16, 2011 (CN) 202040687U

(51) Int. Cl. H01R 33/00

(52) U.S. Cl. 362/641

(57) ABSTRACT

Embodiments of the invention are directed to a projection night light for illuminating a user-selected area of a room with an aesthetic or decorative pattern of light. In particular, there is provided a projection night light, which includes a body shell, and a spherical turning unit operatively coupled to the body shell. The spherical turning unit includes a cavity and a slide having a pattern thereon. The projection night light further includes a light source arranged in the cavity of the spherical turning unit. The light source is configured to pass light through the pattern on the slide forming a patterned light. The spherical turning unit is configured to project and direct the patterned light into a user-selected area of a room.

### RELATED APPLICATION

This application claims the benefit of and priority to Chinese Patent Application No. 201120108650, filed on Apr. 7, 2011, now Chinese Utility Model Patent No. CN202040687U, issued on Nov. 16, 2011, which is incorporated herein in its entirety.

### BACKGROUND

1. Field of the Invention

Embodiments of the invention generally relate to a lamp, and more particularly, to a projection night light for illuminating a user-selected area of a room with an aesthetic or decorative pattern of light.

2Description of the Related Art

Various night lights are available on the market which allow people to work in a room at night without disturbing others while they sleep. Conventional night lights include a shade, an illuminating device arranged in the shade, and a base operatively coupled to the shade. The base may include a power plug and power switch, and may be electrically coupled to the illuminating device via a power switch. While some conventional night lights use an incandescent light bulb to illuminate an area of the room, other conventional night lights use a light emitting diode (LED) as a substitute for the incandescent light bulb. The LED night light includes a printed circuit board, which may be arranged inside the base of the night light, for converting alternating current of a main supply source into voltage to power the LED for illuminating the room. The LED night light provides a longer service life and conserves more energy than the conventional incandescent night light.

Most conventional night lights provide general area-source illumination, i.e., provide a large illumination area over a short distance, without the benefit of an aesthetic or decorative effect, and therefore may still affect sleeping individuals to some extent. Therefore, what is needed is a night light which is capable of directing the projected light away from sleeping individuals, while projecting an aesthetic or decorative pattern of light into the room. For example, one type of conventional night light, as disclosed in Chinese Patent Publication No. CN 2643158Y, includes a spherical turning unit arranged in a body shell fitted to a base of the night light, which can be rotated in an arc for directing light into the room. However, this night light is not capable of providing any visually patterned projection of light.

### SUMMARY

Embodiments of the invention are directed to a projection night light for illuminating a user-selected area of a room with an aesthetic or decorative pattern of light. In particular, there is provided a projection night light, which includes a body shell, and a spherical turning unit operatively coupled to the body shell. The spherical turning unit includes a cavity and a slide having a pattern thereon. The projection night light further includes a light source arranged in the cavity of the spherical turning unit. The light source is configured to pass light through the pattern on the slide forming a patterned light. The spherical turning unit is configured to project and direct the patterned light into a user-selected area of a room.

### BRIEF DESCRIPTION OF DRAWINGS

So that the manner in which the features and advantages of the invention, as well as others which will become apparent, may be understood in more detail, a more particular description of the invention briefly summarized above may be had by reference to the embodiments thereof which are illustrated in the appended drawings, which form a part of this specification. It is to be noted, however, that the drawings illustrate only various embodiments of the invention and are therefore not to be considered limiting of the invention's scope as it may include other effective embodiments as well.

FIG. 1 shows a schematic diagram of a projection night light, in accordance with an embodiment of the invention.

FIG. 2 shows an assembly view of the projection night light shown in FIG. 1, in accordance with an embodiment of the invention.

FIG. 3 shows another assembly view of the projection night light shown in FIG. 1, in accordance with an embodiment of the invention.

FIG. 4 shows a schematic diagram of the projection night light shown in FIG. 1 in one rotational configuration, in accordance with an embodiment of the invention

FIG. 5 shows another schematic diagram of the projection night light shown in FIG. 1 in another rotational configuration, in accordance with an embodiment of the invention.

### DETAILED DESCRIPTION

Although the following detailed description contains many specific details for purposes of illustration, it is understood that one of ordinary skill in the relevant art will appreciate that many examples, variations, and alterations to the following details are within the scope and spirit of the invention. Accordingly, the exemplary embodiments of the invention described herein are set forth without any loss of generality, and without imposing limitations, relating to the claimed invention. Like numbers refer to like elements throughout. Prime notation, if used, indicates similar elements in alternative embodiments.

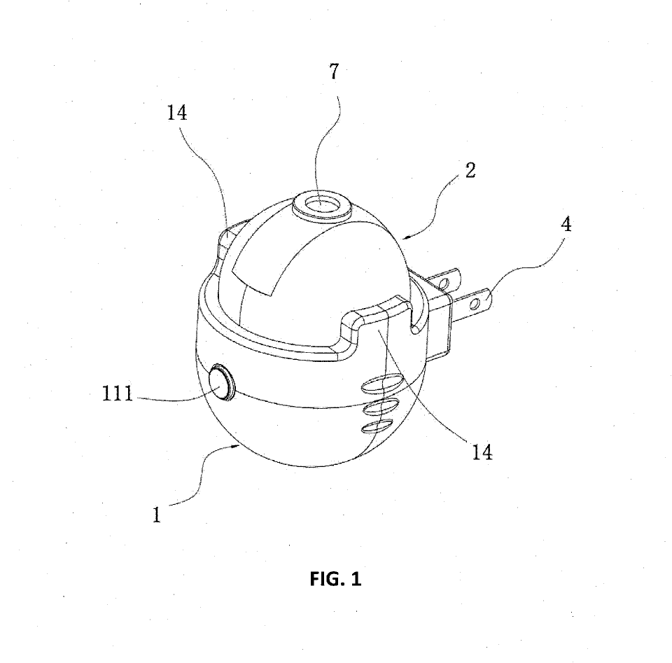

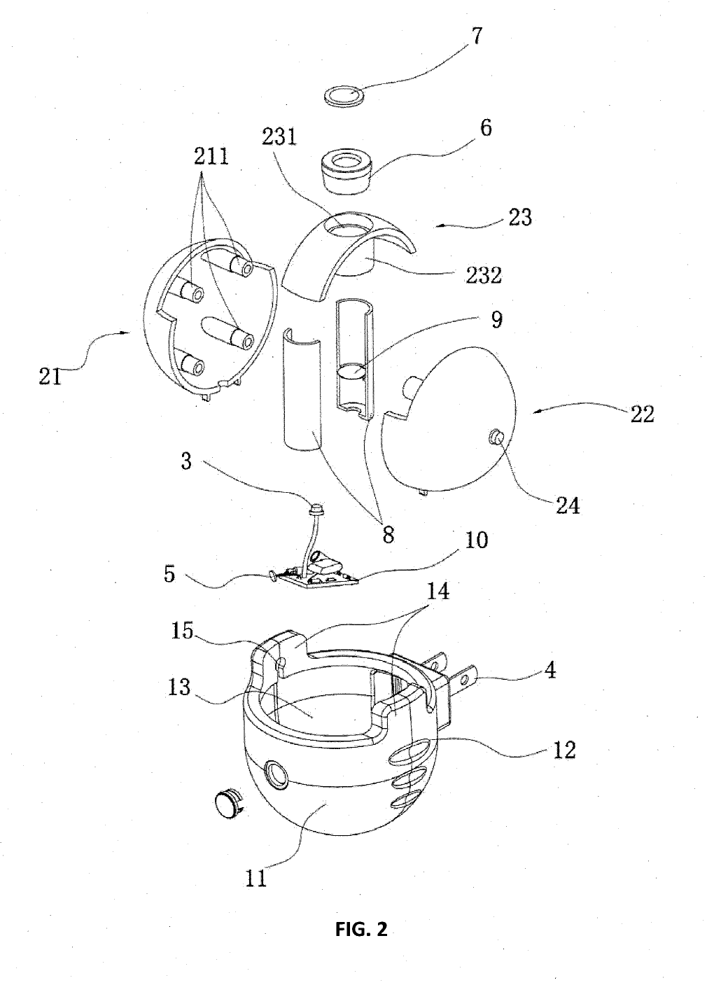

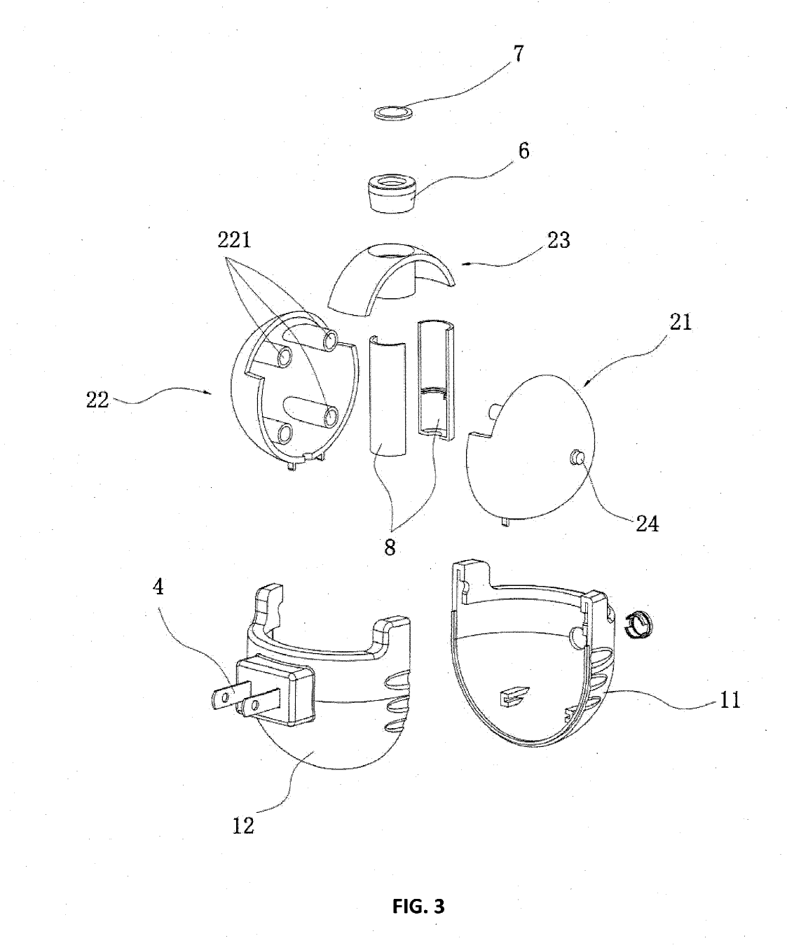

FIG. 1 shows a schematic diagram of a projection night light, in accordance with an embodiment of the invention. FIGS. 2 and 3 show assembly views of the projection night light shown in FIG. 1, in accordance with an embodiment of the invention. As shown in FIGS. 1-3, the projection night light may include a shell 1, a spherical turning unit 2, and a light source 3. In accordance with certain embodiments of the invention, the shell 1 is formed by detachably connecting a body shell 11 and a base shell 12 to form an inner cavity 13. An opening in the inner cavity 13 is formed by the detachable connection of the body shell 11 and the base shell 12. In accordance with an embodiment of the invention, the body shell 11 and the base shell 12 are formed as ¼ spherical parts which form a hollow hemisphere when connected. The opening in the inner cavity 13 is formed in an upper plane of the hollow hemisphere. A power source, for example, power plug 4, is molded to a side of the base shell 12. The projection night light may further include a viewing window 111 and a light resistor 5 positioned behind the viewing window 111 in the shell 1. In accordance with another embodiment of the invention, the body shell 11 and the base shell 12 are molded to form a pair of symmetric flanges or lugs 14 on a top surface of the body shell 11 and the base shell 12, adjacent to the opening of the inner cavity 13. Limiting slots 15 are formed in the inner walls of the lugs 14.

As shown in FIGS. 2 and 3, the spherical turning unit 2 may include a hollow sphere including two hemispheres 21 and 22, and a curved portion 23. In accordance with various embodiments of the invention, one of the two hemispheres 21 and 22 includes a plurality of posts 211, for example, four posts, on an inner surface thereof, and the other of the two hemispheres 21 and 22 includes a plurality of corresponding sockets 221 on the inner surface thereof. When the plurality of posts 211 and the plurality of sockets 221 are aligned and pressed together, the two hemispheres 21 and 22 may be firmly connected to one another. As further shown in FIGS. 2 and 3, the outer surfaces of the two hemispheres 21 and 22 may each include a short cylindrical protrusion 24 that fits into a corresponding limiting slot 15 for movably securing and allowing the spherical turning unit 2 to rotate within the inner cavity 13 of the shell 1 of the projection night light assembly.

In accordance with an embodiment of the invention, a light hole 231 is molded on the curved portion 23, which after installation, is aligned with the opening of the inner cavity 13 of the shell 1. A projection lens 7, which may include a single-sided or double-sided convex lens, may be installed in the light hole 231 via a fitting seat 6. In accordance with an embodiment of the invention, the curved portion 23 extends inward to form a tube 232. As shown in FIGS. 2 and 3, a barrel 8, which includes two halves of a cylinder, may be inserted into the tube 232 in line with the light hole 231.

The light source 3 may include a light emitting source, for example, a LED, installed at the bottom of the barrel 8. An adjustable slide 9 may be positioned in the barrel 8. In accordance with an embodiment of the invention, the slide 9 includes a light-transmitting sheet having a pattern. The pattern may be selected by an individual user, and may include an image that, when projected from the projection night light, creates an aesthetic or decorative pattern of light in the room.

In accordance with another embodiment of the invention, the shell 1 includes a printed circuit board 10 which converts alternating current of a main supply source into voltage to power the light source 3. Both the light resistor 5 and the light source 3 may be coupled, both mechanically and electrically, to the printed circuit board 10.

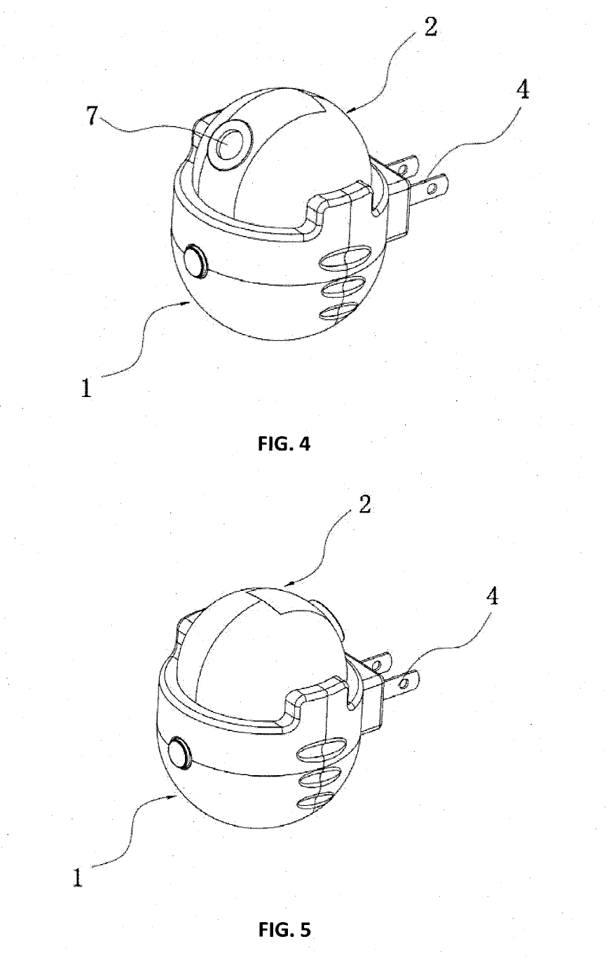

In operation, when the power plug 4 is inserted into an outlet in the wall, the light source 3 will turn on and project light though the slide 9, and the pattern positioned thereon, and the projection lens 7 of the spherical turning unit 2 to form an aesthetic or decorative pattern of light in the room. In accordance with an embodiment of the invention, the spherical turning unit 2, as shown in FIGS. 4 and 5, may be adjusted to direct the pattern of light to fall on any user-selected area of the room. Accordingly, the projection night light, in accordance with various embodiments of the invention, is capable of directing light into an area of a room, for example, away from sleeping individuals, while projecting an aesthetic or decorative pattern of light into the room to enhance the aesthetic or decorative effect of the light from the projection night light.

Embodiments of the present invention may suitably comprise, consist or consist essentially of the elements disclosed and may be practiced in the absence of an element not disclosed. For example, it can be recognized by those skilled in the art that certain steps can be combined into a single step.

Unless defined otherwise, all technical and scientific terms used have the same meaning as commonly understood by one of ordinary skill in the art to which this invention belongs.

The singular forms “a”, “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, terms such as “first” and “second” are arbitrarily assigned and are merely intended to differentiate between two or more components of an apparatus. It is to be understood that the words “first” and “second” serve no other purpose and are not part of the name or description of the component, nor do they necessarily define a relative location or position of the component. Furthermore, it is to be understood that the mere use of the term “first” and “second” does not require that there be any “third” component, although that possibility is contemplated under the scope of the embodiments of the present invention.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A projection night light, comprising:
a body shell;
a spherical turning unit operatively coupled to the body shell, wherein the spherical turning unit comprises a cavity and a slide having a pattern thereon; and
a light source arranged in the cavity of the spherical turning unit, wherein the light source is configured to pass light through the pattern on the slide forming a patterned light,
wherein the spherical turning unit is configured to project and direct the patterned light into a user-selected area of a room.

2. The projection night light of claim 1, wherein the body shell comprises a first shell portion and a second shell portion, wherein the first and the second shell portions are configured to form an inner cavity in the body shell.

3. The projection night light of claim 1, further comprising:
a power plug operatively coupled to the body shell.

4. The projection night light of claim 1, further comprising:
a pair of symmetrical flanges arranged on a top surface of the body shell, wherein the pair of symmetrical flanges are configured to receive and to rotationally secure the spherical turning unit to the body shell.

5. The projection night light of claim 1, wherein the spherical turning unit comprises a first hemisphere portion and a second hemisphere portion, wherein the first hemisphere and the second hemisphere are operatively coupled to one another so as to rotationally secure the spherical turning unit in the body shell.

6. The projection night light of claim 5, wherein the spherical turning unit comprises a projection lens configured to project the patterned light into the user-selected area of the room.

7. The projection night light of claim 1, wherein the slide is adjustable and is arranged in the cavity of the spherical turning unit.

8. The projection night light of claim 1, further comprising:
a printed circuit board configured to provide power to the light source.
